(19) United States
(12) Patent Application Publication
(10) Pub. No.: US 2002/0144744 A1
(43) Pub. Date: Oct. 10, 2002

(54) Multilayer pipe for hydrocarbon-containing fluids

(75) Inventor: Janos Kertesz, Hofheim (DE)

Correspondence Address: Friedrich Kueffner, Suite 1921, 342 Madison Avenue, New York, NY, 10173, US

(73) Assignee: Rasmussen GmbH

(21) Appl. No.: 10/085,253

(22) Filed: Feb. 27, 2002

(30) Foreign Application Priority Data
Apr. 10, 2001 (DE) 101 17 915.4
Apr. 21, 2001 (DE) 101 19 584.2

(51) Int. Cl. F16L 9/14; F16L 11/00

(52) U.S. Cl. 138/137; 138/141

(57) ABSTRACT

A multilayer pipe for hydrocarbon-containing fluids, particularly fluids for internal combustion engines, includes at least four coextruded layers, wherein a first layer contains essentially polyamide and a second layer contains essentially a polyolefin copolymer. For improving the diffusion blocking capability, particularly relative to gasoline, and a higher thermal stability, a third layer contains essentially a thermoplastic polyester and a fourth layer contains essentially a thermoplastic etherester elastomer (TEEE) or a thermoplastic polyester elastomer.

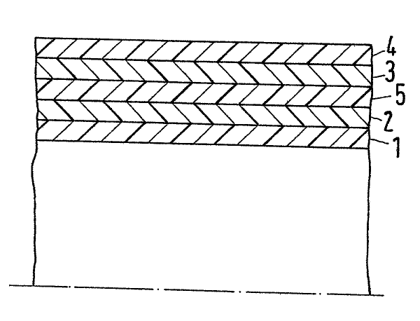

### BACKGROUND OF THE INVENTION

1. Field of the Invention

The present invention relates to a multilayer pipe for hydrocarbon-containing fluids, particularly fluids for internal combustion engines, with at least four coextruded layers.

2. Description of the Related Art

A multilayer pipe of this type disclosed in EP 0 428 833 Bl has five layers, wherein the innermost layer is of PA6, the outermost layer of PA11 or PA12 and a middle layer of PA6. A dissolving inhibitor layer of a copolymer and vinyl alcohol is formed between the innermost layer and the middle layer, and a bonding agent of polyethylene or polypropylene is formed between the middle layer and the outermost layer. While this pipe has a high diffusion blocking capability against hydrocarbon-containing fuels, it does not have a sufficient dimensional stability at higher temperatures. The diffusion blocking capability against alcohol-containing fluids is also not sufficient.

### SUMMARY OF THE INVENTION

Therefore, it is the primary object of the present invention to provide a multilayer pipe of the above-described type which has an improved diffusion blocking capability against fuels, particularly fuels for spark ignition engines (gasoline), and a higher thermal dimensional stability.

In accordance with the present invention, this object is met in a multilayer pipe for hydrocarbon-containing fluids, particularly fuels for internal combustion engines, which has at least four extruded layers, wherein a first layer has essentially at least one of the materials polyamide, polyethylene, polypropylene, and polybutylene, a second layer has essentially a polyolefin copolymer, a third layer essentially a thermoplastic polyester, and a fourth layer essentially a thermoplastic etherester elastomer (TEEE) or a thermoplastic polyester elastomer.

In accordance with this solution, not only the second layer, but also the third and fourth layers each form a diffusion blocking layer. Moreover, the third layer which contains thermoplastic polyester ensures a high dimensional stability even at temperatures of above 100° C. The thermoplastic etherester elastomer (TEEE) of the fourth layer has a high impact strength and, because of its high density of about 1.28 g/cm³, also a high diffusion blocking capability. The same is true for the thermoplastic polyester elastomer which additionally ensures a high flexibility. Since altogether three diffusion blocking layers are provided, the overall permeability to fuel is very low, even when the multilayer pipe has a small wall thickness. Nevertheless, these blocking layers can be integrally completely connected in the molten state during the coextrusion, either with or without bonding agent.

The polyolefin copolymer preferably is an ethylene vinyl alcohol. This material has a very high blocking capability relative to alcohol-free motor vehicle fuels.

The polyamide of the first layer may be a PA6. This plastic material has a very high resistance to chemicals.

The polyester of the third layer may be a polybutylene terephthalate (PET) or a polybutylene naphthalate (PEN). These materials produce a particularly high thermal dimensional stability and diffusion blocking capability relative to alcohol-containing fuels.

Preferably, the arrangement of the individual layers is selected in such a way that the first layer is the innermost layer, that the second layer surrounds the first layer, and the third layer is located between the second layer and the fourth layer. This sequence of layers is advantageous because ethylene vinyl alcohol should not come directly into contact with fuel. The diffusion blocking capability is otherwise reduced if the fuel contains some water, as is usually the case. TEEE should be located on the outside because it has a high cold impact strength. PA6 should be located on the inside because it should not be located on the outside due to its insufficient resistance to zinc chloride. PBT should be the second layer from the outside because it can be welded or melted to TEEE without bonding agent.

A fifth layer, essentially containing a functionalized polyolefine, is preferably located between the second layer and the third layer. This fifth layer is advantageous for connecting the second and third layers to each other if these layers are not modified in such a way that they can be melted without bonding agent. Because of its high polarity, the functionalized polyolefin is capable of being thermally integrally connected to the second layer, on the one hand, and to the third layer, on the other hand.

The functionalized polyolefin of the fifth layer is preferably a glycidil methacrylate copolymer or a maleic acid anhydride-grafted polyolefin. These materials have a very high polarity and, therefore, are capable of being very securely thermally integrally connected to the second layer, on the one hand, and to the third layer, on the other hand.

In order to achieve a tighter connection of the first layer with the adjacent layer, the polyethylene, polypropylene and polybutylene of the first layer should be functionalized.

A particularly tight connection can be achieved if the polyethylene, polypropylene and polybutylene of the first layer are copolymers.

Preferably, at least one of the layers is cross-linked. This further improves the thermal dimensional stability and the blocking capability against hydrocarbon-containing fluids.

The various features of novelty which characterize the invention are pointed out with particularity in the claims annexed to and forming a part of the disclosure. For a better understanding of the invention, its operating advantages, specific objects attained by its use, reference should be had to the drawing and descriptive matter in which there are illustrated and described preferred embodiments of the invention.

### BRIEF DESCRIPTION OF THE DRAWING

In the drawing:

The single FIGURE of the drawing is a partial axial cross-sectional view of an embodiment of a multilayer pipe according to the present invention.

### DESCRIPTION OF THE PREFERRED EMBODIMENTS

The multilayer pipe illustrated in the drawing as an example is composed of a first layer 1 which contains essentially polyamide, preferably PA6, a second layer 2 which contains essentially polyolefin copolymer, preferably an ethylene vinyl alcohol (EVOH), a third layer 3 which contains essentially a thermoplastic polyester, preferably a PBT or PBN, a fourth layer 4 which contains essentially a TEEE or a thermoplastic polyester elastomer, and a fifth layer 5 which is located between the second layer 2 and the third layer 3 and contains essentially a functionalized polyolefine, preferably a glycidil methacrylate copolymer or a maleic acid anhydride-grafted polyolefin.

The first layer 1 forms the innermost layer, the second layer 2 surrounds the first layer, and the third layer 3 is located between the second layer 2 and the fourth layer 4, wherein the fourth layer 4 is the outermost layer.

This multilayer pipe is particularly suitable for fuels of motor vehicles, such as gasoline (fuels for spark ignition engines), and has a very high diffusion blocking capability relative to such fuels, but also relative to other hydrocarbon-containing fluids. Moreover, the multilayer pipe has a high dimensional stability even at higher temperatures which exceed 100° C. The use of TEEE not only produces a high diffusion blocking capability, but also a high impact strength. PBT and PBN increase the thermal dimensional stability and diffusion blocking capability especially relative to alcohol-containing fuels.

In order to prevent EVOH from coming into direct contact with fuels, it is located between the first and third layers. The diffusion blocking capability would otherwise be reduced if the fuel contains some water, as is usually the case. If TEEE is used, it should be located on the outside because of its high cold impact strength. PA6 should be located on the inside in order to prevent it from possibly coming into contact with zinc chloride.

In order to achieve a tighter connection of the first layer 1 with the adjacent layer 2, the polyethylene, polypropylene, and polybutylene of the first layer 1 should be functionalized.

A particularly tight connection can be achieved if the polyethylene, polypropylene and polybutylene of the first layer 1 are copolymers.

Preferably, at least one of the layers 1 to 5 is cross-linked. This further improves the thermal stability and the blocking capability against hydrocarbon-containing fluids.

The fifth layer 5 can be omitted if the second layer 2 and the third layer 3 are modified in such a way that they can be melted together without bonding agent. The use of functionalized polyolefin for the fifth layer 5 has the advantage that because of its high polarity it can be thermally integrally connected with the second layer 2, on the one hand, and with the third layer 3, on the other hand.

In accordance with a modified embodiment, the first layer 1 may have as its principal component not only polyamide, but, alternatively or additionally to polyamide, at least one of the materials polyethylene, polypropylene and polybutylene.

While specific embodiments of the invention have been shown and described in detail to illustrate the inventive principles, it will be understood that the invention may be embodied otherwise without departing from such principles.

I claim:

1. A multilayer for hydrocarbon-containing fluids, particularly fuels for internal combustion engines, the multilayer pipe comprising at least four coextruded layers, wherein
a first layer essentially contains at least one of the material polyamides, polyethylene, polypropylene and polybutylene;
a second layer contains essentially a polyolefin copolymer;
a third layer contains essentially a thermoplastic polyester; and
a fourth layer essentially contains a thermoplastic etherester elastomer (TEEE) or a thermoplastic polyester elastomer.

2. The multilayer pipe according to claim 1, wherein the polyolefin copolymer is a ethylene vinyl alcohol (EVOH).

3. The multilayer pipe according to claim I, wherein the polyamide of the first layer is a PA6.

4. The multilayer pipe according to claim 1, wherein the polyester of the third layer is a polybutylene terephthalate (PBT) or a polybutylene naphthalate (PBN)

5. The multilayer pipe according to claim 1, wherein the first layer is the innermost layer, the second layer surrounds the first layer, and the third layer is located between the second layer and the fourth layer.

6. The multilayer pipe according to claim 5, further comprising a fifth layer between the second layer and the third layer, wherein the fifth layer contains essentially a functionalized polyolefin.

7. The multilayer pipe according to claim 6, wherein the functionalized polyolefin of the fifth layer is a glycidil methacrylate copolymer or a maleic acid anhydride-grafted polyolefin.

8. The multilayer pipe according to claim I, wherein the polyethylene, polypropylene and polybutylene of the first layer are functionalized.

9. The multilayer pipe according to claim 1, wherein the polyethylene, polypropylene and polybutylene of the first layer are copolymers.

10. The multilayer pipe according to claim 6, wherein at least one of the layers is cross-linked.
